(19) United States
(12) Patent Application Publication
(10) Pub. No.: US 2023/0357941 A1
(43) Pub. Date: Nov. 9, 2023

(54) SYSTEMS AND METHODS FOR HYDROGEN AND AMMONIA PRODUCTION

(71) Applicant: Ohmium International, Inc., Incline Village, NV (US)

(72) Inventors: Arne Ballantine, Lugano (CH); Chockkalingam Karuppaiah, Fremont, CA (US); Rasool Aghatehrani, Redwood City, CA (US)

(21) Appl. No.: 18/144,727

(22) Filed: May 8, 2023

Related U.S. Application Data
(60) Provisional application No. 63/338,971, filed on May 6, 2022.
(60) Provisional application No. 63/444,808, filed on Feb. 10, 2023.

(51) Int. Cl. C25B 15/08; C25B 1/04; C25B 9/23; C25B 13/08; C25B 1/46; B01D 53/32; C02F 1/42; C02F 1/461; C02F 1/467; C01B 3/02; C01C 1/04

(52) U.S. Cl. CPC C25B 15/081; C25B 1/04; C25B 9/23; C25B 13/08; C25B 15/085; C25B 1/46; B01D 53/326; C02F 1/42; C02F 1/46104; C02F 1/4672; C01B 3/025; C01C 1/0417; B01D 2257/108; C02F 2103/08

(57) ABSTRACT

Provided herein are systems and methods for generating hydrogen and ammonia. The hydrogen is generated in an anion exchange membrane-based electrochemical stack. The hydrogen generated in the stack may be used to generate ammonia or may be used for other applications requiring hydrogen. The feedstock for the anion exchange membrane-based electrochemical stack may be saline water, such as seawater. A desalination module or a chlor-alkali stack may be used to treat the saline water prior to electrolysis in the anion exchange membrane-based electrochemical stack.

### CROSS-REFERENCE TO RELATED APPLICATIONS

This application claims priority to U.S. Provisional Application No. 63/444,808 entitled “SYSTEM AND METHODS FOR MODULAR WATER DESALINATION SYSTEM USING WATER ELECTROLYZER WASTE HEAT”, filed Feb. 10, 2023, and to U.S. Provisional Application No. 63/338,971 entitled “SYSTEMS AND METHODS OF AMMONIA SYNTHESIS”, filed May 6, 2022, the entire contents of each of which are incorporated herein by reference.

### BACKGROUND OF THE INVENTION

Hydrogen is a common gas that has many industrial uses, such as petroleum refining, metal treatment, food processing, and ammonia production. One method of producing hydrogen includes electrolyzing water to produce oxygen and hydrogen gas. This process may be done in an electrolyzer that includes a polymer membrane to separate the oxygen and hydrogen. Generally, very pure water is required in electrolyzer systems.

### SUMMARY OF THE INVENTION

Provided herein are systems for generating hydrogen and ammonia. The systems use saline water or other unpurified water sources for generating the hydrogen.

The systems generally comprise: an electrochemical stack for generating hydrogen, including an inlet operable to receive water from a water source and an anion exchange membrane, wherein the first electrochemical stack electrolyzes the water to generate hydrogen; and a reactor for generating ammonia including an inlet operable to receive nitrogen and hydrogen generated in the electrochemical stack, and an energy source activatable to reduce nitrogen to ammonia in the presence of hydrogen. In some embodiments, the water source comprises saline water. In some additional embodiments, the saline water comprises sodium and chloride salts.

In some embodiments, the energy source includes a synthesis cell having a cathode, an anode, and a proton exchange membrane disposed between the cathode and the anode. In some additional embodiments, the proton exchange membrane comprises a perfluorosulfonic acid polymer or copolymer, sulfonated poly(ether ether ketone) (sPEEK), sulfonated phenylated poly(phenylene) (sPPP), sulfonated polyether (sulfone) (SPES), sulfonated polystyrene-b-poly(ethylene-r-butylene-b-polystrene (S-SEBS), or combinations thereof.

In some embodiments the electrochemical stack further includes a cathode and an anode, and the anion exchange membrane is disposed between the cathode and the anode. In some additional embodiments, the anion exchange membrane includes imidazolium functionalized styrene polymers, polysulfone and derivatives thereof, polymers with quaternary phosphonium groups, or combinations thereof. In still further embodiments, the electrochemical stack further includes a first outlet operable to deliver hydrogen from the electrochemical stack, and a second outlet operable to deliver a secondary gas comprising oxygen from the electrochemical stack.

In some embodiments, the system further comprises a desalination system fluidly coupled to the electrochemical stack to provide desalinated water to the electrolchemical stack. In some embodiments, the system further comprises an ion exchange system fluidly coupled to the water source and to the electrochemical stack.

In some embodiments, the system further comprises a chlor-alkali stack fluidly coupled to the water source and to the electrochemical stack. In some aspects, the chlor-alkali stack includes an anode, a cathode, and a proton exchange membrane. In some embodiments, the system further comprises a hydrogen storage system fluidly coupled to the electrochemical stack.

In some embodiments, the system further comprises an electrochemical hydrogen pump fluidly coupled to an outlet of the ammonia reactor to remove unreacted hydrogen gas. In some aspects, the electrochemical hydrogen pump includes an anode, a cathode, and a proton exchange membrane.

In some embodiments, the system further comprises a phase separator fluidly coupled to an outlet of the electrochemical stack to remove water from the generated hydrogen. In some aspects, the phase separator is fluidly coupled to the inlet of the ammonia reactor.

Further provided herein are systems for generating hydrogen and ammonia. The systems generally comprise a desalination system operable to remove salts from saline water, thereby generating desalinated water; an electrochemical stack for generating hydrogen including: an electrochemical stack for generating hydrogen, including an inlet operable to receive water from a water source and an anion exchange membrane, wherein the first electrochemical stack electrolyzes the water to generate hydrogen; and a reactor for generating ammonia including an inlet operable to receive nitrogen and hydrogen generated in the electrochemical stack, and an energy source activatable to reduce nitrogen to ammonia in the presence of hydrogen.

Further provided herein are systems for generating hydrogen and ammonia. The systems generally comprise a chlor alkali stack operable to remove chlorine from saline water, thereby generating dechlorinated water; an electrochemical stack for generating hydrogen including: an electrochemical stack for generating hydrogen, including an inlet operable to receive water from a water source and an anion exchange membrane, wherein the first electrochemical stack electrolyzes the water to generate hydrogen; and a reactor for generating ammonia including an inlet operable to receive nitrogen and hydrogen generated in the electrochemical stack, and an energy source.

In some embodiments, the system further comprises an ion exchange system in fluid communication with the chlor-alkali stack and the electrochemical stack, wherein the ion exchange system receives an amount of the dechlorinated water generated by the chlor-alkali stack to produce deionized water. In some aspects, the deionized water is combined with the amount of the dechlorinated water not received by the ion exchange system before entering the electrochemical stack. In some aspects, the system further comprises a valve operable to adjust the amount of sodium hydroxide solution delivered to the ion exchange system.

Further provided herein are systems for generating hydrogen. The systems generally comprise an electrochemical stack for generating hydrogen including: an inlet operable to receive water from a water source; an anion exchange membrane, wherein the first electrochemical stack electrolyzes the water to generate hydrogen; and an outlet to be fluidly coupled to a reactor for generating ammonia.

Further provided herein are methods for generating hydrogen and ammonia. The methods generally comprise generating hydrogen in an electrochemical stack including: an inlet operable to receive water from a water source, and an anion exchange membrane, wherein the first electrochemical stack electrolyzes the water to generate hydrogen; and generating ammonia in a reactor including: an inlet operable to receive nitrogen and hydrogen generated in the electrochemical stack; an energy source activatable to reduce nitrogen to ammonia in the presence of hydrogen. In some embodiments, the water comprises saline water. In some embodiments, the method comprises storing hydrogen generated by the electrochemical stack.

In some embodiments, the method further comprises dechlorinating saline water in a chlor-alkali stack and delivering the dechlorinated water to the inlet of the electrochemical stack.

In some embodiments, the method further comprises desalinating saline water and delivering the desalinated water to the inlet of the electrochemical stack. In some embodiments, the method further comprises transferring heat generated by the electrochemical stack to a desalination system via a heat exchange fluid.

In some embodiments the method further comprises deionizing the water in an ion exchange system and delivering the deionized water to the inlet of the electrochemical stack.

### BRIEF DESCRIPTION OF DRAWINGS

FIGS. 1A-1B show an exemplary system of the present disclosure including an AEM electrolyzer stack and an ammonia reactor. FIG. 1A shows the overall system and FIG. 1B shows another view of the AEM electrolyzer stack and related components.

FIGS. 2A-2B show an exemplary system of the present disclosure including an AEM electrolyzer stack, an ammonia reactor, and a chlor-alkali stack. FIG. 2A shows the overall system and FIG. 2B shows another view of the AEM electrolyzer stack, the chlor-alkali stack, and related components.

FIGS. 3A-3B show an exemplary system of the present disclosure including an AEM electrolyzer stack, an ammonia reactor, a chlor-alkali stack, and a desalination system. FIG. 3A shows the overall system and FIG. 3B shows another view of the AEM electrolyzer stack, the chlor-alkali stack, the desalination system, and related components.

FIGS. 4A-4B show an exemplary system of the present disclosure including an AEM electrolyzer stack, an ammonia reactor, and a desalination system. FIG. 4A shows the overall system and FIG. 4B shows another view of the AEM electrolyzer stack, the desalination system, and related components.

### DETAILED DESCRIPTION OF THE INVENTION

Provided herein are systems and methods for producing hydrogen and ammonia. The systems and methods described herein use an anion exchange membrane (AEM) electrochemical stack to produce hydrogen via electrolysis. The ammonia may be generated through various different means as described herein using the hydrogen produced in the AEM stack. Alternatively or additionally, the hydrogen produced in the AEM stack may be stored and used for purposes other than generating ammonia. Use of the AEM stack to produce the hydrogen may be preferred over other methods of hydrogen generation because the AEM stack may use saline water (e.g., seawater) as a water source for the electrolysis without additional purification.

### I. Systems

The systems of the present disclosure include one or more electrochemical stacks that comprise AEM electrolyzer stacks. When more than one AEM electrolyzer stack is included in the system, the AEM electrolyzer stacks may be connected in parallel. Electrolyzer stacks for membrane-based electrolysis of water to produce hydrogen are generally known and described in the relevant art. An AEM electrolyzer cell includes a cathode, an anode, and an anion exchange membrane disposed between the cathode and the anode. An AEM electrolyzer stack may include multiple AEM electrolyzer cells, i.e., multiple cathode-AEM-anode cells. The AEM electrolyzer stack may further include pumps, valves, conduits, ventilation systems, power electronics, and other components necessary to provide safe and efficient generation of the hydrogen.

In use, as described in greater detail below, water and electricity may be provided to the AEM-based electrolyzer stack, where some of the water may be electrochemically electrolyzed to form hydrogen (e.g., via hydrogen ion diffusion through an AEM electrolyte from a cathode side of the electrolyzer to the anode side of the AEM electrolyzer). For example, a water circuit comprising pumps, valves, piping, etc., may be actuatable to deliver water to the AEM-based electrochemical stack. The water may be delivered using methods known in the art, such as by pumping. As the water moves through the AEM-based electrochemical stack, power delivered to the AEM-based electrochemical stack may move protons of at least some of the water through the AEM electrolyte to form hydrogen. Anions, such as hydroxyl anions, may be captured in the anion exchange membrane and may be moved to the anode of the AEM-based electrochemical stack.

Anion exchange membranes, and method of making and procuring the same, are generally known to those having ordinary skill in the art. In some embodiments, the anion exchange membrane may include imidazolium functionalized styrene polymers, polymers including quarternary ammonium groups, polysulfone and derivatives thereof, polymers with quaternary phosphonium groups, polymers with anion exchange groups incorporated into the polymeric backbone, and other anion exchange materials known in the art.

The water delivered to the AEM-based electrochemical stack may be purified water, tap water, well water, industrial wastewater, non-industrial wastewater, deionized water, fresh water (e.g., water from a lake, river, pond, stream, etc.; <0.05% salt content), saline water (e.g., seawater; 3%-5% salt content), or brackish water (0.05%-3% salt content). Generally, the water may have a salt content of about 5% by weight or less, about 4% by weight or less, about 3% by weight or less, about 2% by weight or less, about 1% by weight or less, about 0.1% by weight or less, or about 0.05% by weight or less. The water may be from a single source or from multiple sources of differing quality.

When using saline water or brackish water, those having ordinary skill in the art will appreciate that the chemical composition of the salt content of the saline water or brackish water may differ depending on where the water is collected. Generally, saline water includes chlorine, sodium, magnesium, sulfate, calcium, and potassium salts. The anions (i.e., chlorine and sulfate) may be conducted by the anion exchange membrane.

The water delivered to the AEM electrolyzer stack may be purified using an ion exchange system. The ion exchange system includes an ion exchange column. Water is delivered to the ion exchange column via methods known in the art such as pumping, where it contacts an ion exchange media to capture and remove ionized impurities from the water. The ion exchange column may be a co-current, counter-current, or mixed bed ion exchange column. Suitable ion exchange media include cation resins and anion resins. Examples of suitable media for ion exchange are generally known in the art, and include polymers with sulfonic acid groups, polymers with quaternary amino groups, polymers with carboxylic acid groups, and polymers with primary, secondary, and tertiary amines. Specific polymers for use in ion exchange resins include cross-linked polystyrene (e.g., polystyrene crosslinked with divinylbenzene), sodium polystyrene sulfonate, PolyAMPS, polyAPTAC, and other polymers known in the art. The system may include multiple ion exchange columns connected in parallel such that when the ion exchange media in one column has no more capacity for ion exchange, another column may be used while the media in the first column is regenerated.

The deionized water may be delivered directly into the AEM-based electrolyzer stack, or may be combined with an amount of non-deionized water to optimize the properties of the water (e.g., conductivity, pH, concentration of specific ions, etc.) to improve the efficiency of the electrolysis reaction.

The electricity provided to the AEM electrolyzer stack preferably includes renewable energy sources, such as solar, wind, hydroelectric, geothermal, etc. The electricity provided to the AEM electrolyzer stack may be sourced from a power grid, such as a regional, municipal, or private power grid. The electricity provided to the AEM electrolyzer stack may be sourced from an energy storage mechanism or a plurality of energy storage mechanisms. The energy storage mechanism may comprise any mechanism or apparatus operable to store energy such as electricity, thermal energy, etc. For example, the energy storage mechanism may include batteries (e.g., lead-acid batteries, lithium ion batteries, lithium iron batteries, etc.), ice, water, flywheels, compressed air, pumped hydroelectric, or other energy storage mechanisms known in the art and combinations thereof.

The hydrogen generated by the AEM electrolyzer stack may be stored in a hydrogen storage system, it may be delivered to a customer for use, or it may be provided to an ammonia reactor as described further herein.

The AEM electrolyzer stack may include two outlets. The first outlet may be fluidly coupled the cathode side of the AEM electrolyzer stack and is operable to deliver hydrogen generated in the AEM electrolyzer stack. The hydrogen may be delivered by methods known in the art for transporting hydrogen. The second outlet may fluidly coupled to the anode side of the AEM electrolyzer stack and is operable to deliver oxygen gas generated in the AEM electrolyzer stack. The hydrogen may be delivered by methods known in the art for transporting oxygen.

The hydrogen produced in the AEM electrolyzer stack may be delivered to a phase separator. The phase separator is operable to condense water and other impurities to purify the hydrogen gas. The phase separator may be a two-phase separator. The phase separator preferably includes a vertical knockout drum. Methods of making and sizing knockout drums suitable for separating water from hydrogen gas are well known to those having ordinary skill in the art.

The phase separator comprises an inlet portion and an outlet portion. The inlet portion is operable to receive wet hydrogen from the AEM electrolyzer stack. The hydrogen gas may have a purity from about 95% to about 98%, wherein the major impurity is water. The outlet portion may comprise a first outlet operable to deliver dry hydrogen. The dry hydrogen may be low pressure hydrogen, e.g., from about 1 bar to about 2 bar. The outlet portion may further comprise a second outlet to deliver the water separated from the wet hydrogen. The water may be delivered by methods known in the art, such as by pumping. The second outlet may be fluidly coupled to the AEM electrolyzer stack to recycle the water and to reduce the amount of total water required by the system.

Additionally or alternatively, the hydrogen may be directed to a dryer to remove excess water and increase the purity of the hydrogen. The dryer may include, for example, a pressure swing adsorption (PSA) system, a temperature swing adsorption (TSA) system, a hybrid PSA-TSA system, or a membrane purifier. The dryer comprises an inlet portion and an outlet portion. The inlet portion is operable to receive wet hydrogen. The hydrogen gas may have a purity of about 95% to about 98%, wherein the major impurity is water. The outlet portion includes a first outlet operable to provide dry hydrogen. The dry hydrogen may be low pressure hydrogen, e.g., from about 1 bar to about 2 bar. The dryer may further include a second outlet to deliver the water separated from the wet hydrogen. The water may be delivered by methods known in the art, such as by pumping. The water stream may include some of the hydrogen gas produced in the AEM electrolyzer stack. The water stream may comprise hydrogen having a concentration from about 0% to about 25% by weight. The second outlet may be fluidly coupled to the AEM electrolyzer stack to recycle the water and to reduce the amount of total water required by the system.

The dryer may include one or more beds of a water-adsorbent material, such as activated carbon, silica, zeolite or alumina. The dryer may include a membrane such as a PEM electrolyte. As the gas consisting essentially of hydrogen and water moves through from the inlet portion to the outlet portion of the dryer, at least a portion of the water may be removed from the product mixture through adsorption of either water or hydrogen in the bed of water-adsorbent material. If hydrogen is adsorbed, then it is removed into the outlet conduit during a pressure and/or temperature swing cycle. If water is adsorbed, then it is removed into a pump conduit during the pressure and/or temperature swing cycle. In some instances, adsorption carried out by the dryer may be passive, without the addition of heat or electricity that could otherwise act as ignition sources of an ignitable hydrogen-containing mixture. In such instances, however, considerations related to backpressure created by the dryer in fluid communication with the electrochemical stack may limit the size and, therefore, the single-pass effectiveness of the dryer in removing moisture from the product stream.

In some embodiments, the hydrogen may be directed to a hydrogen pump to increase hydrogen purity and/or pressure. In particular embodiments where the hydrogen is delivered to an ammonia reactor, a hydrogen pump may not be used, as the hydrogen may be used at ambient pressures. The delivering may be accomplished by methods known in the art for transporting hydrogen. In other embodiments where the hydrogen is to be stored or used for other purposes, higher pressures of hydrogen may be required.

The hydrogen pump may comprise a hydrogen recirculation stack. The hydrogen recirculation stack comprises an inlet portion and an outlet portion. The first inlet is operable to receive hydrogen produced in the AEM electrolyzer stack. The hydrogen may be wet hydrogen or it may be dried hydrogen that has passed through a dryer or a phase separator. The outlet portion comprises a first outlet operable to provide a stream of purified hydrogen. The first outlet may be fluidly connected to a hydrogen storage system or to a system or process requiring purified hydrogen, such as the fuel cell stack. In preferred embodiments, the first outlet of the hydrogen recirculation stack is fluidly connected to the fuel cell stack. The second outlet may comprise a purge stream comprising hydrogen, oxygen, and/or water. The second outlet may be recycled in the system of the present disclosure, or the second outlet may vent to the atmosphere. For example, the water in the purge stream may be recycled to the AEM electrolyzer stack for electrolysis.

The pressure of the hydrogen provided to the hydrogen pump is generally from about 1 bar to about 2 bar; however, the pressure may be higher or lower depending on the requirements of the system and the equipment used.

The AEM electrolyzer stack may include a heat exchanger. The heat exchanger is thermally coupled to the AEM electrolyzer stack to absorb heat generated by the AEM-electrolyzer. The heat exchanger may include any heat exchanger known in the art. For example, the heat exchanger may comprise a shell and tube heat exchanger, a double tube heat exchanger, a tube-in-tube heat exchanger, a plate heat exchanger, a plate and shell heat exchanger, an adiabatic wheel heat exchanger, a plate fin heat exchanger, a finned tube heat exchanger, a pillow plate heat exchanger, or combinations thereof. The heat exchanger may comprise a heat exchange fluid to absorb heat generated by the electrolyzer. The heat exchange fluid may comprise air, water, steam, a mixture of water and glycol, a silicon fluid, a molten salt, or other fluids known in the art useful for heat exchange. The heat may then be delivered to another component in the system, such as a desalination module. The delivering may be accomplished using methods generally known in the art, such as by pumping a heat exchange fluid containing the heat to another component in the system.

The ammonia reactor may be fluidly coupled to a nitrogen source and to a hydrogen source. Preferably, the hydrogen source includes an AEM electrolyzer stack as described herein, but may alternatively or additionally be fluidly coupled to a hydrogen storage system that in turn is fluidly coupled to an AEM electrolyzer stack. The ammonia reactor may have a single-pass yield below one-hundred percent and, in some cases, below single-pass yield levels associated with a Haber-Bosch reactor (e.g., a metal catalyst, such as an Fe catalyst) operated at elevated temperature (e.g., about 400° C.) and elevated pressure (e.g., about 200 atm). In some embodiments, the reactor may have a single-pass yield of greater than 0% and less than 15%. Outputs from the ammonia reactor may include ammonia (NH₃) and unreacted nitrogen and hydrogen gas. As explained further below, the unreacted hydrogen may be recovered using an electrochemical hydrogen pump and recycled to the ammonia reactor to improve the overall efficiency of the system.

The nitrogen source may comprise a nitrogen storage vessel, such as nitrogen tank or a device which separates oxygen and nitrogen. In one embodiment, the nitrogen source may remove nitrogen from air (e.g., from compressed air) to form nitrogen and nitrogen-dilute air. For example, the nitrogen source may include one or more of a pressure swing adsorber, a temperature swing adsorber, a hybrid pressure and thermal swing adsorber, or a refrigeration unit. Further, or instead, the nitrogen source may include an electrochemical cell operable to electrochemically pump nitrogen or oxygen from air. The outputs of the nitrogen source may include nitrogen and nitrogen-depleted air (e.g., air with more than 21 percent oxygen). In certain implementations, the nitrogen-depleted air may be directed to one or more cascading stages of nitrogen removal process for separation of additional nitrogen from the nitrogen-depleted air to form more nitrogen.

In another embodiment, the nitrogen source may remove oxygen from air (e.g., from compressed air) to form nitrogen-dilute air and oxygen. For example, the nitrogen source may include an electrochemical cell operable to electrochemically pump oxygen from air. The outputs of the nitrogen source may include oxygen and oxygen-depleted air (e.g., air with less than 21 percent oxygen) which is provided into the reactor 102. In certain implementations, the oxygen-depleted air may be directed to one or more cascading stages of oxygen removal process for separation of additional oxygen from the oxygen-depleted air to increase its nitrogen concentration.

The nitrogen (or oxygen depleted air) produced by the nitrogen source may be directed to the inlet of the reactor via a nitrogen stream. The nitrogen flowable from the nitrogen source to the reactor may include certain non-oxygen impurities from the compressed air and/or from the process used to separate oxygen from the compressed air. Such impurities (e.g., carbon dioxide and/or argon) may be acceptable to the extent the given impurity does not interfere with the formation of ammonia in the system and does not degrade any one or more of the various different portions of the system.

The reactor may comprise an electrochemical ammonia reactor (i.e., a membrane type electrochemical reactor). The reactor comprises an energy source that includes a proton exchange membrane (PEM) operable for electrochemical synthesis of ammonia from hydrogen and nitrogen. The electrochemical ammonia reactor may include an anode, a cathode, and a proton exchange membrane disposed between the anode and cathode. The electrochemical ammonia reactor may include a power source connected to the anode and to the cathode to create an electric field in the PEM disposed between the anode and the cathode (i.e., to apply a voltage between the anode and the cathode).

The hydrogen may be introduced to the anode of the electrochemical ammonia reactor where it breaks down into protons. Under the electric field created by the power source, the protons may flow from the anode to the cathode through the proton exchange membrane. At the cathode, the nitrogen is introduced into the reactor and may flow over the cathode, where the nitrogen may react with the protons to form ammonia. Optionally, additional hydrogen may also be provided directly to the cathode in addition to the hydrogen pumped through the proton exchange membrane.

The proton exchange membrane may include a perfluorosulfonic acid polymer or copolymer, such as a sulfonated tetrafluoroethylene-based fluoropolymer-copolymer. The proton exchange membrane may alternatively or additionally include sulfonated poly(ether ether ketone) (sPEEK), sulfonated phenylated poly(phenylene) (sPPP), sulfonated polyether (sulfone) (SPES), sulfonated polystyrene-b-poly(ethylene-r-butylene-b-polystrene (S-SEBS), or combinations thereof. In some examples, the proton exchange membrane may comprise a Nafion® membrane having the formula C₇HF₁₃O₅·C₂F₄. In some additional examples, the proton exchange membrane may comprise Selemion CMV, Neosepta CMS, Fumasep FKS 30, or combinations thereof.

In other embodiments, the ammonia reactor may comprise a low-yield catalyst (e.g., a catalyst operated at temperatures and pressure less than those associated with conventional Haber-Bosch processes) or a plasma-driven reactor. Ammonia reactors of this type are generally known in the relevant art.

The output of the ammonia reactor may be fluidly coupled to an electrochemical hydrogen pump. The electrochemical hydrogen pump may remove unreacted hydrogen flowing along the product stream and recirculate this unreacted hydrogen to the inlet of the reactor. Recirculation of hydrogen in this manner may increase the overall yield of the reactor by displacing at least a portion of the hydrogen that would otherwise be required to be formed by the hydrogen source to meet the input demands of the reactor.

The hydrogen pump may be an electrochemical membrane hydrogen pump which includes one or more electrochemical cells. Each of the electrochemical cells may include an anode, a cathode, and a proton exchange membrane disposed between the anode and the cathode. Electrical power supplied to the hydrogen pump creates an electric field which may result in a high pressure concentrated along the cathode as compared to the anode. At the anode, lower pressure hydrogen may separate into protons and electrons, and the electrical field may drive protons across the proton exchange membrane to the cathode. The protons may then recombine at the cathode to form hydrogen at a higher pressure.

A cascade of hydrogen pumps connected in series may increase the output hydrogen to a desired pressure. This hydrogen may be delivered back to the ammonia reactor to react with nitrogen gas, or it may be stored or used for other purposes. The delivering may be accomplished by methods known in the art. In general, the target pressure may be at least above a minimum pressure required to deliver the recovered hydrogen to one or more reactant streams at or upstream of the inlet of the ammonia reactor. Pressures above the minimum pressure may be useful for, among other things, controlling the ratio of recycled hydrogen to non-recycled hydrogen from the hydrogen source. That is, with increasing pressure above the minimum pressure, the relative amount of recycled hydrogen used to meet the total hydrogen demand of the ammonia reactor increases. The upper end of a pressure range useful for controlling the fraction of recycled hydrogen in the total hydrogen may be bounded by considerations such as, but not limited to, the total power required by the electrochemical hydrogen pump compared to the power required by the hydrogen source, hardware, safety, or combinations thereof.

The output of the ammonia reactor may alternatively or additionally be fluidly coupled with a phase separator. The phase separator may be operable to condense at least a portion of the ammonia from the output of the ammonia reactor before or after excess hydrogen has been removed. The ammonia may be condensed by the phase separator and be drained and stored for further use. The remaining nitrogen gas and any additional excess hydrogen may be vented to the atmosphere or may be recycled to the ammonia reactor to improve process efficiency.

In some embodiments, the system may include a water desalination system. Water desalination systems are capable of lowering the salt content of saline or brackish water. The water desalination system may be operable to provide purified water to the AEM electrolyzer stack. Preferably, the purified water produced from the desalination system has a conductivity from about 10 μS/m³ to about 50 μS/m³.

The desalination system may utilize one or more methods of desalination known in the art, such as distillation (e.g., solar distillation, evaporation, vacuum distillation, multi-stage flash distillation, membrane distillation), osmosis (e.g., reverse osmosis), freeze-thaw, electrodialysis, or microbial distillation, or combinations thereof. Preferably, the desalination system utilizes a membrane-based distillation method, such as a reverse osmosis desalination system or an electrodialysis desalination system.

Generally, water desalination systems require heat to move water through the membranes that separate impurities from the water. Thus, the desalination system may include a heat exchanger that is thermally coupled with one or more components of the system described herein, such as an AEM electrolyzer stack, an ammonia reactor, or a chlor-alkali stack, or a combination thereof. Preferably, the desalination system is thermally coupled with the AEM electrolyzer stack via a heat exchanger.

The heat exchanger may include any heat exchanger known in the art. For example, the heat exchanger may comprise a shell and tube heat exchanger, a double tube heat exchanger, a tube-in-tube heat exchanger, a plate heat exchanger, a plate and shell heat exchanger, an adiabatic wheel heat exchanger, a plate fin heat exchanger, a finned tube heat exchanger, a pillow plate heat exchanger, or combinations thereof. The heat exchanger may comprise a heat exchange fluid to absorb heat generated by the electrolyzer. The heat exchange fluid may comprise air, water, steam, a mixture of water and glycol, a silicon fluid, a molten salt, or other fluids known in the art useful for heat exchange.

The desalinated water generated by the desalination system may be provided directly to the AEM electrolyzer stack. Alternatively, a portion of the desalinated water may be provided to an ion exchange system as described herein. The portion of desalinated water provided to the ion exchange system may be predetermined based on the conductivity of the water entering the AEM electrolyzer stack as measured by one or more conductivity meters. Conductivity meters and methods of measuring conductivity are generally well-known in the art. One or more flow control valves may adjust the flow of desalinated water and deionized water entering the AEM electrolyzer stack based on an input received from the conductivity meter(s). The flow control valves may be any valve known in the art suitable for controlling the flow of the water. In another embodiment, the desalinated water may be combined with unpurified water from a water source (e.g., saline water). The flow of the unpurified water may also be adjusted by a flow control valve based on the conductivity of the water entering the AEM electrolyzer stack.

In some embodiments, the system may include a chlor-alkali electrolyzer stack (also referred to herein as a “chlor-alkali stack”). The chlor-alkali process is known in the art for the electrolysis of aqueous solutions of sodium chloride to form hydrogen, chlorine (Cl₂), and aqueous sodium hydroxide (NaOH). The process operates in a similar fashion for solutions that include calcium chloride or potassium chloride.

The chlor-alkali stack includes an electrolyzer comprising an anode, a cathode, and a proton exchange membrane disposed between the anode and cathode. Electricity is passed through the stack to generate an electric field. Saline water is delivered to anode side of the chlor-alkali stack using methods generally known in the art, such as by pumping. The chloride ions in the saline water oxidize at the anode to form chlorine gas and cations (e.g., sodium, potassium, or calcium cations). The chlorine gas elutes from the solution and is collected. The cations pass through the polymer exchange membrane to the cathode side of the stack. At the cathode, hydrogen ions are reduced to form hydrogen gas and hydroxyl ions. The hydroxyl ions react with the cations to produce a basic solution. The basic solution may comprise sodium hydroxide, potassium hydroxide, or calcium hydroxide.

The hydrogen gas may be collected from the chlor-alkali stack and pressurized and/or stored for further use. Alternatively, the hydrogen may be purified for use in the ammonia reactor described herein by use of an electrochemical hydrogen pump.

The chlor-alkali stack may include a heat exchanger. The heat exchanger is thermally coupled to the chlor-alkali stack to absorb heat generated by the chlor-alkali stack. The heat exchanger may comprise a heat exchange fluid such as propylene glycol or water to absorb heat generated by the electrolyzer. The heat may then be delivered to another component in the system, such as a heat sink or, more preferably, to an ammonia reactor as described herein to improve the efficiency of the ammonia reaction. Alternatively, or additionally, the heat may be delivered to a desalination module as described herein to improve the efficiency of the desalination. The delivering may be accomplished by methods known in the art, such as pumping the heat exchange fluid from one system component to another.

The water delivered to the chlor-alkali stack may be saline water (e.g., seawater; 3%-5% salt content), or brackish water (0.05%-3% salt content). Generally, the water may have a salt content of about 5% by weight or less, about 4% by weight or less, about 3% by weight or less, about 2% by weight or less, about 1% by weight or less, about 0.1% by weight or less, or about 0.05% by weight or less.

The dechlorinated water generated by the chlor-alkali stack may be provided directly to the AEM electrolyzer stack. Alternatively, a portion of the dechlorinated water may be provided to an ion exchange system as described herein. The portion of dechlorinated water provided to the ion exchange system may be predetermined based on the conductivity of the water entering the AEM electrolyzer stack as measured by one or more conductivity meters. Conductivity meters and methods of measuring conductivity are generally well-known in the art. One or more flow control valves may adjust the flow of dechlorinated water and deionized water entering the AEM electrolyzer stack based on an input received from the conductivity meter(s). The flow control valves may be any valve known in the art suitable for controlling the flow of the water.

The system may further comprise one or more heat sinks to absorb excess heat generated by the system. The heat sinks may include seawater, air radiators, geothermal cooling or other cooling systems known in the art. The heat sinks may be thermally coupled to one or more heat exchangers in the system.

The system may further comprise a hydrogen storage system. Systems and methods for storing hydrogen are generally well-known in the art, for example, storage tanks. The hydrogen storage system may be fluidly coupled with the AEM electrolyzer stack to store the hydrogen produced by the stack. The hydrogen storage system may comprise pressurized hydrogen. The pressurized hydrogen may be stored at a pressure from about 350 bar to about 700 bar; for example, about 350 bar, 400 bar, 450 bar, 500 bar, 550 bar, 600 bar, 650 bar, or about 700 bar. Compressors and/or electrochemical hydrogen pumps such as those described herein may be used to pressurize the hydrogen for storage.

The system may further comprise a chlorine storage system. Systems and methods for storing chlorine are generally well-known in the art, for example, storage tanks.

The system may further comprise an oxygen storage system. Systems and methods for storing oxygen are generally well-known in the art, for example, storage tanks.

The system may further comprise power electronics. The power electronics may be formed or provided in a single assembly that electrically connects one or more system components with an electricity source. For example, the power electronics may be electrically coupled with one or more of the AEM electrolyzer stack stack, the ammonia reactor, a hydrogen recirculation pump, a chlor-alkali stack, a desalination module, or to the other system components descried herein. The power electronics may be operable to electrically connect to DC energy inputs, AC energy inputs, and combinations thereof. The power electronics may further be operable to connect to DC energy loads, AC energy loads, and combinations thereof. The power electronics may comprise a GaN inverter board, and integrated power board, control cards, a display board, and/or a DAB converter. In some embodiments, the power electronics may be the power electronics described in U.S. application Ser. No. 17/360,153 entitled “IMPEDANCE MONITORING OF A MODULAR ELECTROLYSIS SYSTEM”, the contents of which are incorporated by reference herein in their entirety.

The system may further comprise a controller. The controller may be operably connected to one or more of the system components described hereinabove. The controller is operable to adjust various parameters of the system and based on various inputs received, such as temperature, flow rate, pressure, current, voltage, conductivity, humidity, etc. The controller may also be operable to turn one or more system components off and on.

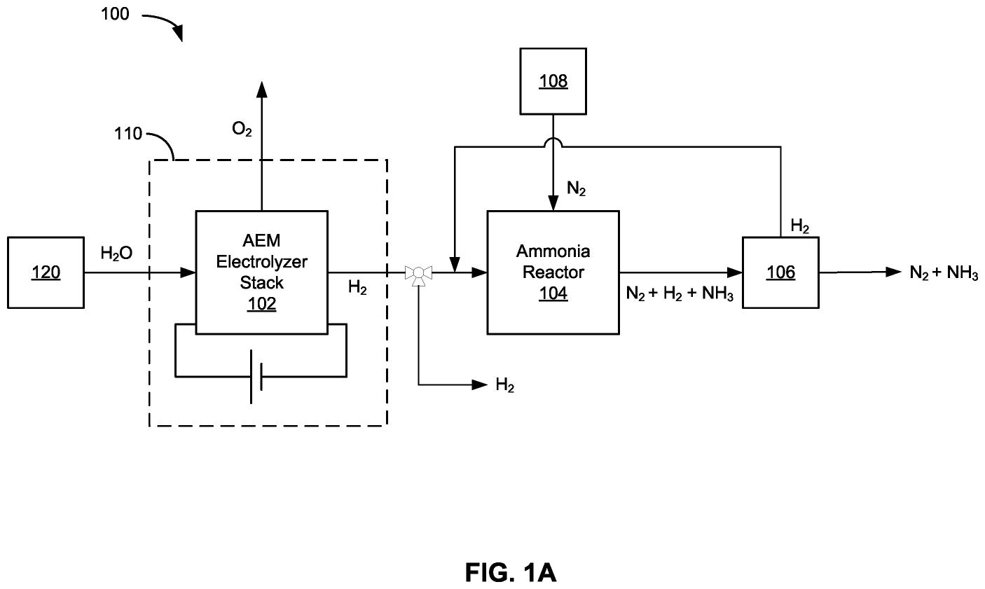

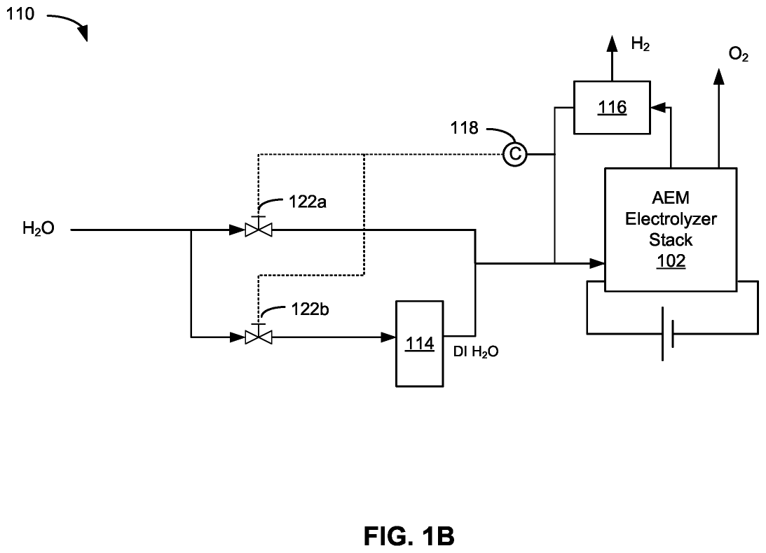

Turning now to the figures, FIG. 1 shows an exemplary system 100 of the present disclosure. System 100 includes a water source 120 that is fluidly coupled with an AEM electrolyzer stack 102 to provide water to the AEM electrolyzer stack 102. The water may be deionized in a deioinization bed 114 (see FIG. 1B) in subsystem 110 as described herein to remove salts and other impurities in the water. Oxygen produced by the AEM electrolyzer stack 102 may be vented to the atmosphere or it may be collected. AEM electrolyzer stack 102 is fluidly coupled to an ammonia reactor 104. The hydrogen gas produced by AEM electrolyzer stack 102 may be delivered to the ammonia reactor 104 or may be stored or provided for another use. The ammonia reactor 104 is fluidly coupled to a nitrogen source 108. The nitrogen source 108 provides nitrogen gas to the ammonia reactor 104. The ammonia reactor 104 produces a mixture of ammonia, hydrogen, and nitrogen. The unreacted hydrogen is separated from the ammonia and nitrogen via a hydrogen pump 106 fluidly coupled to the ammonia reactor. The hydrogen is recycled to the inlet portion of the ammonia reactor 104 for reuse. Alternatively, the hydrogen may be stored or provided for another use. The nitrogen and ammonia are collected for processing and use.

In FIG. 1B, subsystem 110 shows an exemplary system for deionizing water prior to delivering it to the AEM electrolyzer stack 102. The water is fluidly coupled to the AEM electrolyzer stack 102 and to an ion exchange system 114. The water is split into two streams, wherein each stream is controlled by a flow control valve 122a, 122b. Flow control valve 122a controls the flow rate of water fed directly to the AEM electrolyzer stack 102. Flow control valve 122b controls the flow rate of water fed to the ion exchange system 114. The AEM electrolyzer stack 102 is also fluidly coupled to a phase separator 116, which is operable to remove excess water and other impurities from the hydrogen gas produced by the AEM electrolyzer stack 102. The phase separator 116 recycles the excess water back to the AEM electrolyzer stack 102 for electrolysis. Alternatively, the water may be purged from the system 100. A conductivity meter 118 determines the conductivity of the water emerging from the phase separator 116. The flow control valves 122a, 122b may adjust the flow rate of the water and of the deionized water delivered to the AEM electrolyzer stack 102 to increase or decrease the conductivity of the water provided to the AEM electrolyzer stack 102 to optimize the performance of the AEM electrolyzer stack 102.

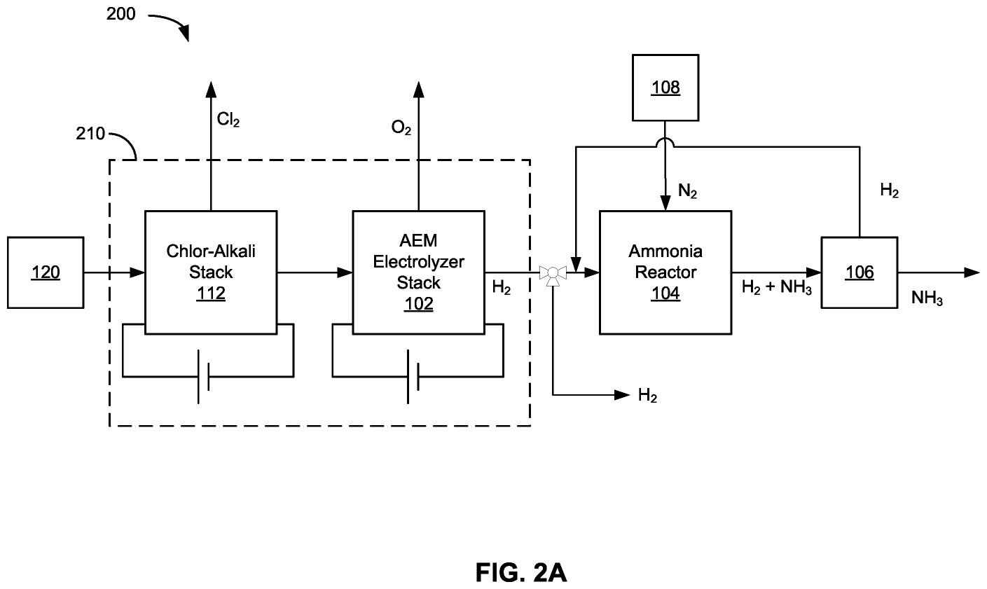

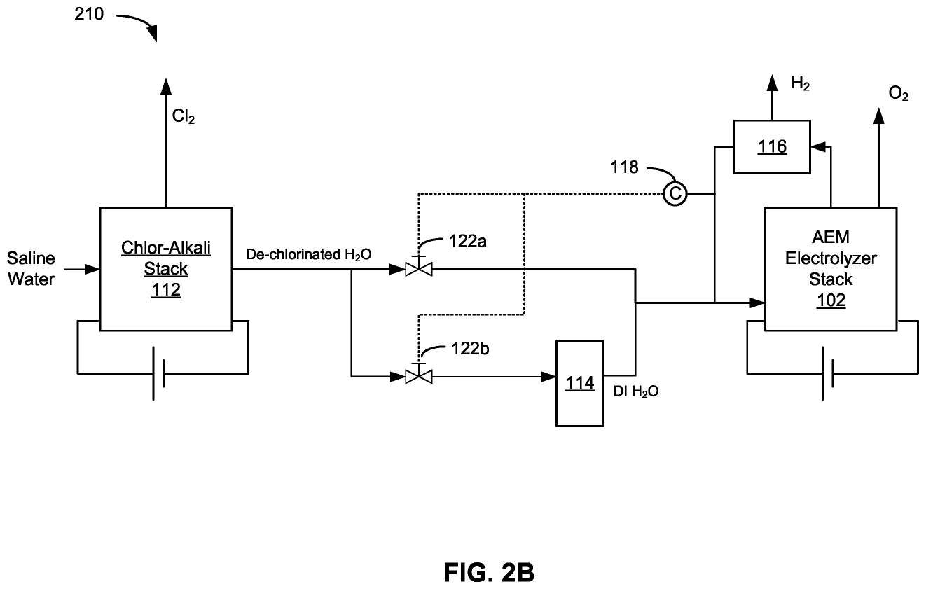

FIG. 2A shows another exemplary system 200 of the present disclosure. System 200 includes a water source 120 that is fluidly coupled with chlor-alkali stack 112 to provide saline water to the chlor-alkali stack 112. The chlor-alkali stack 112 removes chlorine from the saline water in the form of chlorine gas, which may be stored or provided for use. The chlor-alkali stack 112 is fluidly coupled to an AEM electrolyzer stack 102 to provide dechlorinated water to the AEM electrolyzer stack 102. The dechlorinated water may be deionized in a deionization bed 114 (see FIG. 2B) as described herein to remove salts and other impurities in the saline water. Oxygen produced by the AEM electrolyzer stack 102 may be vented to the atmosphere or it may be collected. AEM electrolyzer stack 102 is fluidly coupled to an ammonia reactor 104. The hydrogen gas produced by AEM electrolyzer stack 102 may be delivered to the ammonia reactor 104 or may be stored or provided for another use. The ammonia reactor 104 is fluidly coupled to a nitrogen source 108. The nitrogen source 108 provides nitrogen gas to the ammonia reactor 104. The ammonia reactor 104 produces a mixture of ammonia, hydrogen, and nitrogen. The unreacted hydrogen is separated from the ammonia and nitrogen via a hydrogen pump 106 fluidly coupled to the ammonia reactor. The hydrogen is recycled to the inlet portion of the ammonia reactor 104 for reuse. Alternatively, the hydrogen may be stored or provided for another use. The nitrogen and ammonia are collected for processing and use.

In FIG. 2B, subsystem 210 shows an exemplary system for deionizing water prior to delivering it to the AEM electrolyzer stack 102. The chlor-alkali stack 112 is fluidly coupled to the AEM electrolyzer stack 102 and to an ion exchange system 114. The de-chlorinated water produced from the chlor-alkali stack 112 is split into two streams, wherein each stream is controlled by a flow control valve 122a, 122b. Flow control valve 122a controls the flow rate of dechlorinated water fed to the AEM electrolyzer stack 102. Flow control valve 122b controls the flow rate of dechlorinated water fed to the ion exchange system 114. The AEM electrolyzer stack 102 is also fluidly coupled to a phase separator 116, which is operable to remove excess water from the hydrogen gas produced by the AEM electrolyzer stack 102. The phase separator 116 recycles the excess water back to the AEM electrolyzer stack 102 for electrolysis. Alternatively, the water may be purged from the system 200. A conductivity meter 118 determines the conductivity of the water emerging from the phase separator 116. The flow control valves 122a, 122b may adjust the flow rate of the dechlorinated water and of the deionized water delivered to the AEM electrolyzer stack 102 to increase or decrease the conductivity of the water provided to the AEM electrolyzer stack 102 to optimize the performance of the AEM electrolyzer stack 102.

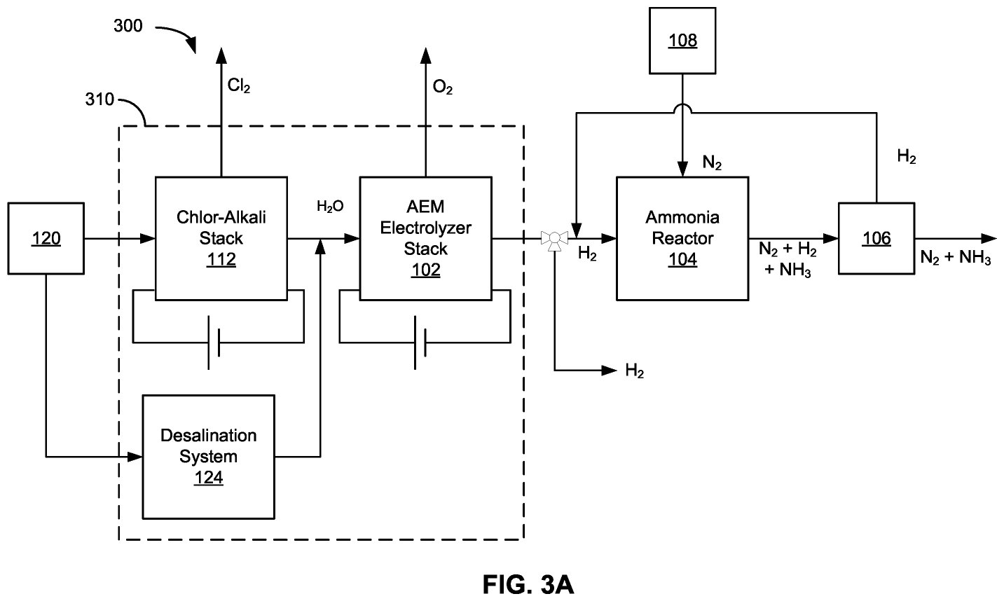

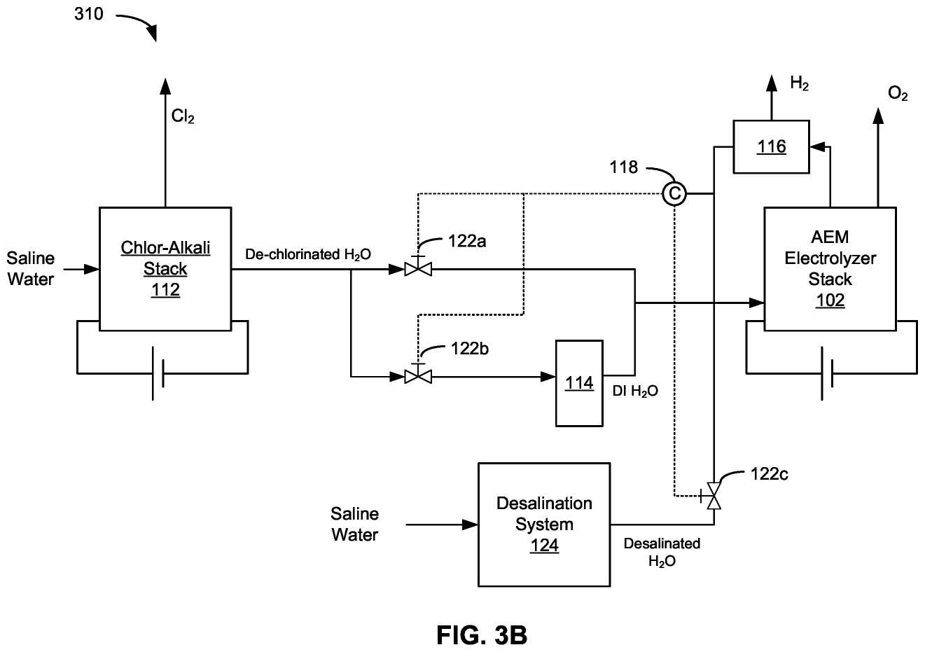

FIG. 3A shows an exemplary system 300 of the present disclosure. System 300 includes a water source 120 that is fluidly coupled with chlor-alkali stack 112 to provide saline water to the chlor-alkali stack 112 and to a desalination system 124 to provide saline water to the desalination system 124. The chlor-alkali stack 112 removes chlorine from the saline water in the form of chlorine gas, which may be stored or provided for use. The chlor-alkali stack 112 is fluidly coupled to an AEM electrolyzer stack 102 to provide dechlorinated water to the AEM electrolyzer stack 102. The desalination system 124 is also fluidly coupled to the AEM electrolyzer stack 102 to provide desalinated water to the AEM electrolyzer stack 102. The dechlorinated water may be deionized in a deionization bed 114 in subsystem 310 (see FIG. 3B) as described herein to remove salts and other impurities in the saline water. Oxygen produced by the AEM electrolyzer stack 102 may be vented to the atmosphere or it may be collected. AEM electrolyzer stack 102 is fluidly coupled to an ammonia reactor 104. The hydrogen gas produced by AEM electrolyzer stack 102 may be delivered to the ammonia reactor 104 or may be stored or provided for another use. The ammonia reactor 104 is fluidly coupled to a nitrogen source 108. The nitrogen source 108 provides nitrogen gas to the ammonia reactor 104. The ammonia reactor 104 produces a mixture of ammonia, hydrogen, and nitrogen. The unreacted hydrogen is separated from the ammonia and nitrogen via a hydrogen pump 106 fluidly coupled to the ammonia reactor. The hydrogen is recycled to the inlet portion of the ammonia reactor 104 for reuse. Alternatively, the hydrogen may be stored or provided for another use. The nitrogen and ammonia are collected for processing and use.

In FIG. 3B, subsystem 310 shows an exemplary system for deionizing water prior to delivering it to the AEM electrolyzer stack 102. The chlor-alkali stack 112 is fluidly coupled to the AEM electrolyzer stack 102 and to an ion exchange system 114. The de-chlorinated water produced from the chlor-alkali stack 112 is split into two streams, wherein each stream is controlled by a flow control valve 122a, 122b. The desalination system 124 is also fluidly coupled to the AEM electrolyzer stack 102. The flow of desalinated water provided by the desalination system 124 is controlled by flow control valve 122c. Flow control valve 122a controls the flow rate of dechlorinated water fed to the AEM electrolyzer stack 102. Flow control valve 122b controls the flow rate of dechlorinated water fed to the ion exchange system 114. Flow control valve 122c controls the flow rate of desalinated water fed to the AEM electrolyzer stack 102. The AEM electrolyzer stack 102 is also fluidly coupled to a phase separator 116, which is operable to remove excess water from the hydrogen gas produced by the AEM electrolyzer stack 102. The phase separator 116 recycles the excess water back to the AEM electrolyzer stack 102 for electrolysis. Alternatively, the water may be purged from the system 300. A conductivity meter 118 determines the conductivity of the water emerging from the phase separator 116. The flow control valves 122a, 122b, 122c may adjust the flow rate of the dechlorinated water and of the deionized water delivered to the AEM electrolyzer stack 102 to increase or decrease the conductivity of the water provided to the AEM electrolyzer stack 102 to optimize the performance of the AEM electrolyzer stack 102.

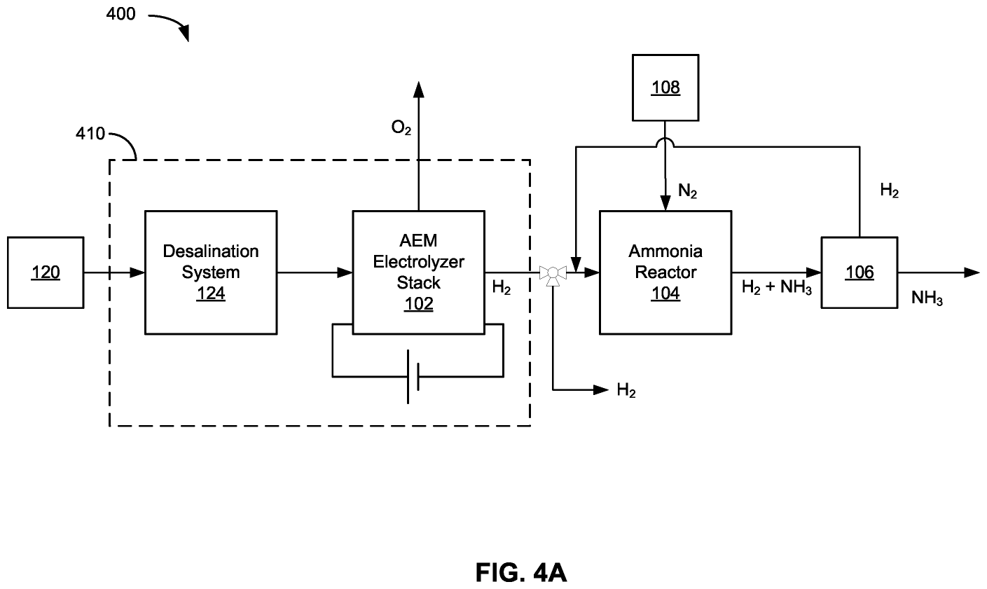

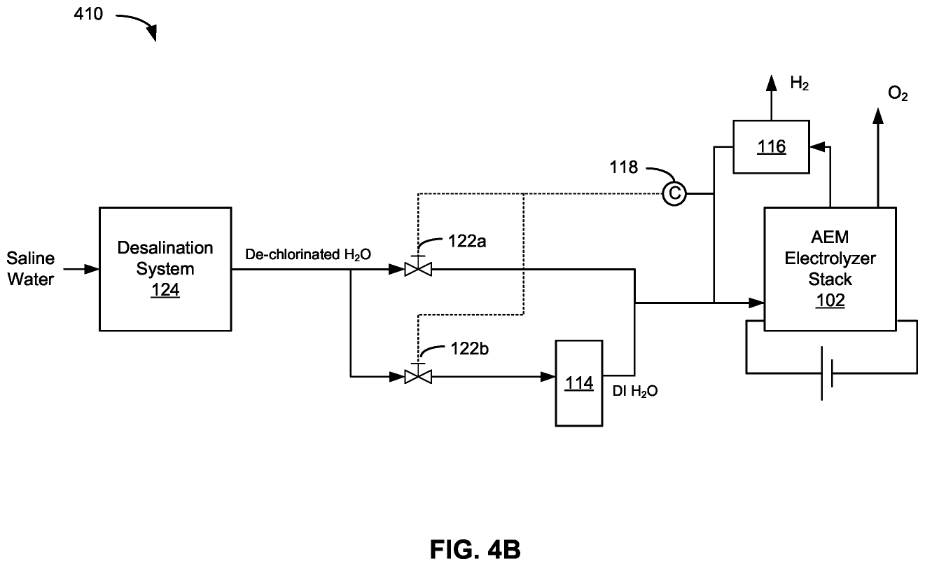

FIG. 4A shows an exemplary system 400 of the present disclosure. System 300 includes a water source 120 that is fluidly coupled with a desalination system 124 to provide saline water to the desalination system 124. The desalination system 124 is fluidly coupled to the AEM electrolyzer stack 102 to provide desalinated water to the AEM electrolyzer stack 102. The desalinated water may be deionized in a deionization bed 114 in subsystem 410 (see FIG. 4B) as described herein to remove salts and other impurities in the saline water. Oxygen produced by the AEM electrolyzer stack 102 may be vented to the atmosphere or it may be collected. AEM electrolyzer stack 102 is fluidly coupled to an ammonia reactor 104. The hydrogen gas produced by AEM electrolyzer stack 102 may be delivered to the ammonia reactor 104 or may be stored or provided for another use. The ammonia reactor 104 is fluidly coupled to a nitrogen source 108. The nitrogen source 108 provides nitrogen gas to the ammonia reactor 104. The ammonia reactor 104 produces a mixture of ammonia, hydrogen, and nitrogen. The unreacted hydrogen is separated from the ammonia and nitrogen via a hydrogen pump 106 fluidly coupled to the ammonia reactor. The hydrogen is recycled to the inlet portion of the ammonia reactor 104 for reuse. Alternatively, the hydrogen may be stored or provided for another use. The nitrogen and ammonia are collected for processing and use.

In FIG. 4B, subsystem 410 shows an exemplary system for deionizing water prior to delivering it to the AEM electrolyzer stack 102. The desalination system 124 is fluidly coupled to the AEM electrolyzer stack 102 and to an ion exchange system 114. The desalinated water produced from the desalination system 124 is split into two streams, wherein each stream is controlled by a flow control valve 122a, 122b. Flow control valve 122a controls the flow rate of desalinated water fed to the AEM electrolyzer stack 102. Flow control valve 122b controls the flow rate of dechlorinated water fed to the ion exchange system 114. The AEM electrolyzer stack 102 is also fluidly coupled to a phase separator 116, which is operable to remove excess water from the hydrogen gas produced by the AEM electrolyzer stack 102. The phase separator 116 recycles the excess water back to the AEM electrolyzer stack 102 for electrolysis. Alternatively, the water may be purged from the system 400. A conductivity meter 118 determines the conductivity of the water emerging from the phase separator 116. The flow control valves 122a, 122b may adjust the flow rate of the desalinated water and of the deionized water delivered to the AEM electrolyzer stack 102 to increase or decrease the conductivity of the water provided to the AEM electrolyzer stack 102 to optimize the performance of the AEM electrolyzer stack 102.

### II. Methods

Further provided herein are methods for generating hydrogen and ammonia. The methods may be performed using any of the systems described in Section I above.

The methods include generating hydrogen in an AEM electrolyzer stack. The generating may be accomplished via the electrolysis of water, such as saline water, fresh water, brackish water, desalinated water, dechlorinated water, purified water, and combinations thereof. The water is pumped to the AEM electrolyzer stack form a water source.

The methods may further include purifying and/or pressurizing the hydrogen generated by the AEM electrolyzer stack. This may be accomplished via an electrochemical hydrogen pump fluidly coupled to the AEM electrolyzer stack. The pressurized and/or purified hydrogen may be stored for later use or provided for additional uses. Alternatively or additionally, the hydrogen may be purified via separation in a phase separator, or by drying the hydrogen gas.

The methods further include generating ammonia in an ammonia reactor. The generating may be accomplished by any of the ammonia reactors described herein. Preferably, the generating is accomplished by an electrochemical ammonia reactor. Nitrogen is provided to the ammonia reactor from a nitrogen source fluidly coupled to the ammonia reactor. Hydrogen may be provided to the ammonia reactor directly from an AEM electrolyzer stack fluidly coupled to the ammonia reactor, or may be provided from a hydrogen storage system fluidly coupled to the ammonia reactor. Additionally, unreacted hydrogen and/or nitrogen may be recycled to the ammonia reactor to improve process efficiency. In some additional embodiments, the ammonia may be purified via separation in a phase separator, such as a condenser.

The methods may further include purifying water prior to providing the water to the AEM electrolyzer stack. In some embodiments, the purifying may be accomplished via electrolysis in a chlor-alkali stack, via desalination in a desalination system, via deionization in an ion exchange system, or a combination thereof.

The electrolysis in the chlor-alkali stack results in the formation of chlorine gas and hydrogen gas. The chlorine gas may be collected and stored. The hydrogen gas may be collected and stored. Optionally, the hydrogen gas may be pressurized and/or purified via an electrochemical hydrogen pump as described herein. The dechlorinated water produced by the chlor-alkali stack may be provided directly to the AEM electrolyzer stack for use or may be further purified.

The desalination results in the formation of desalinated water. The salt impurities removed by the desalination system may be disposed of as waste. The desalinated water produced by the desalination system may be provided directly to the AEM electrolyzer stack for use or may be further purified.

The deionization of the water in the ion exchange system results in the formation of deionized water. The ion impurities removed by the ion exchange system may be disposed of as waste when the ion exchange system is regenerated. The deionized water produced by the ion exchange system may be provided directly to the AEM electrolyzer stack for use or may be further purified.

Although many system components have been described herein as single units, those having ordinary skill in the art will appreciate that multiple of each system component described herein may be present in the system to improve process and efficiency, to effectively scale-up, and/or to provide redundancy.

### Exemplary Embodiments

Embodiment 1: A system for generating hydrogen and ammonia comprising: an electrochemical stack for generating hydrogen including:
an inlet operable to receive water from a water source; and
an anion exchange membrane, wherein the first electrochemical stack electrolyzes the water to generate hydrogen; and
a reactor for generating ammonia including:
   an inlet operable to receive nitrogen and hydrogen generated in the electrochemical stack; and
   an energy source activatable to reduce nitrogen to ammonia in the presence of hydrogen.

Embodiment 2: The system of embodiment 1, wherein the energy source includes a synthesis cell having a cathode, an anode, and a proton exchange membrane disposed between the cathode and the anode.

Embodiment 3: The system of embodiment 1 or 2, wherein the proton exchange membrane comprises a perfluorosulfonic acid polymer or copolymer, sulfonated poly(ether ether ketone) (sPEEK), sulfonated phenylated poly(phenylene) (sPPP), sulfonated polyether (sulfone) (SPES), sulfonated polystyrene-b-poly(ethylene-r-butylene-b-polystrene (S-SEBS), or combinations thereof.

Embodiment 4: The system of any one of embodiments 1-3, wherein the electrochemical stack further includes a cathode and an anode, and the anion exchange membrane is disposed between the cathode and the anode.

Embodiment 5: The system of any one of embodiments 1-4, wherein the anion exchange membrane includes imidazolium functionalized styrene polymers, polysulfone and derivatives thereof, polymers with quaternary phosphonium groups, or combinations thereof.

Embodiment 6: The system of any one of embodiments 1-5, wherein the water source comprises saline water.

Embodiment 7: The system of embodiment 6, wherein the saline water comprises sodium and chloride salts.

Embodiment 8: The system of any one of embodiments 1-7, wherein the electrochemical stack further includes a first outlet operable to deliver hydrogen from the electrochemical stack, and a second outlet operable to deliver a secondary gas comprising oxygen from the electrochemical stack.

Embodiment 9: The system of any one of embodiments 1-8, further comprising a desalination system fluidly coupled to the electrochemical stack to provide desalinated water to the electrolchemical stack.

Embodiment 10: The system of any one of embodiments 1-9, further comprising an ion exchange system fluidly coupled to the water source and to the electrochemical stack.

Embodiment 11: The system of any one of embodiments 1-10, further comprising a chlor-alkali stack fluidly coupled to the water source and to the electrochemical stack.

Embodiment 12: The system of embodiment 11, wherein the chlor-alkali stack includes an anode, a cathode, and a proton exchange membrane.

Embodiment 13: The system of any one of embodiments 1-12, further comprising a hydrogen storage system fluidly coupled to the electrochemical stack.

Embodiment 14: The system of any one of embodiments 1-13, further comprising an electrochemical hydrogen pump fluidly coupled to an outlet of the ammonia reactor to remove unreacted hydrogen gas.

Embodiment 15: The system of embodiment 13, wherein the electrochemical hydrogen pump includes an anode, a cathode, and a proton exchange membrane.

Embodiment 16: The system of any one of embodiments 1-15, further comprising a phase separator fluidly coupled to an outlet of the electrochemical stack to remove water from the generated hydrogen.

Embodiment 17: The system of embodiment 16, wherein the phase separator is fluidly coupled to the inlet of the ammonia reactor.

Embodiment 18: A system for generating hydrogen and ammonia, the system comprising:
a desalination system operable to remove salts from saline water, thereby generating desalinated water;
an electrochemical stack for generating hydrogen including:
   an inlet operable to receive the desalinated water from the desalination module; and
   an anion exchange membrane, wherein the first electrochemical stack electrolyzes the desalinated water to generate hydrogen; and
a reactor for generating ammonia including:
   an inlet operable to receive nitrogen and hydrogen generated in the electrochemical stack; and
   an energy source activatable to reduce nitrogen to ammonia in the presence of hydrogen.

Embodiment 19: A system for generating hydrogen and ammonia, the system comprising:
a chlor alkali stack operable to remove chlorine from saline water, thereby generating dechlorinated water;
an electrochemical stack for generating hydrogen including:
   an inlet operable to receive the dechlorinated water from the chlor alkali stack; and
   an anion exchange membrane, wherein the first electrochemical stack electrolyzes the sodium hydroxide solution to generate hydrogen; and
a reactor for generating ammonia including:
   an inlet operable to receive nitrogen and hydrogen generated in the electrochemical stack; and
   an energy source activatable to reduce nitrogen to ammonia in the presence of hydrogen.

Embodiment 20: The system of embodiment 19, further comprising an ion exchange system in fluid communication with the chlor-alkali stack and the electrochemical stack, wherein the ion exchange system receives an amount of the dechlorinated water generated by the chlor-alkali stack to produce deionized water.

Embodiment 21: The system of embodiment 20, wherein the deionized water is combined with the amount of the dechlorinated water not received by the ion exchange system before entering the electrochemical stack.

Embodiment 22: The system of embodiment 20 or 21, further comprising a valve operable to adjust the amount of sodium hydroxide solution delivered to the ion exchange system.

Embodiment 23: A system for generating hydrogen comprising:
an electrochemical stack for generating hydrogen including:
   an inlet operable to receive water from a water source;
   an anion exchange membrane, wherein the first electrochemical stack electrolyzes the water to generate hydrogen; and
   an outlet to be fluidly coupled to a reactor for generating ammonia.

Embodiment 24: A method for generating hydrogen and ammonia comprising:
generating hydrogen in an electrochemical stack including:
   an inlet operable to receive water from a water source; and
   an anion exchange membrane, wherein the first electrochemical stack electrolyzes the water to generate hydrogen; and
generating ammonia in a reactor including:
   an inlet operable to receive nitrogen and hydrogen generated in the electrochemical stack; and
   an energy source activatable to reduce nitrogen to ammonia in the presence of hydrogen.

Embodiment 25: The method of embodiment 24, wherein the water comprises saline water.

Embodiment 26: The method of embodiment 24 or 25, wherein the water comprises dechlorinated water.

Embodiment 27: The method of embodiment 26, further comprising dechlorinating saline water in a chlor-alkali stack and delivering the dechlorinated water to the inlet of the electrochemical stack.

Embodiment 28: The method of any one of embodiments 24-27, wherein the water comprises desalinated water.

Embodiment 29: The method of embodiment 28, further comprising desalinating the water and delivering the desalinated water to the inlet of the electrochemical stack.

Embodiment 30: The method of embodiment 28 or 29, further comprising transferring heat generated by the electrochemical stack to a desalination system via a heat exchange fluid.

Embodiment 31: The method of any one of embodiments 24-30, wherein the water comprises deionized water.

Embodiment 32: The method of embodiment 31, further comprising deionizing the water in an ion exchange system and delivering the deionized water to the inlet of the electrochemical stack.

Embodiment 33: The method of any one of embodiments 24-32, further comprising storing hydrogen generated by the electrochemical stack.

As used herein, “wet hydrogen” refers to hydrogen that is saturated with water. Those having ordinary skill in the art will appreciate that the amount and/or concentration of water in the wet hydrogen will depend on the temperature and pressure of the wet hydrogen.

As used herein, “dry hydrogen” refers to hydrogen that has a water content of about 10 ppm or less. For example, the dry hydrogen may have a water content of about 10 ppm, about 9 ppm, about 8 ppm, about 7 ppm, about 6 ppm, about 5 ppm, about 4 ppm, about 3 ppm, about 2 ppm, about 1 ppm, or less than about 1 ppm. Preferably, the dry hydrogen has a water content of about 5 ppm or less.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

The above systems, devices, methods, processes, and the like may be realized in hardware, software, or any combination of these suitable for the control, data acquisition, and data processing described herein. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as the various systems described above, or all of the functionality may be integrated into a dedicated, standalone device. All such permutations and combinations are intended to fall within the scope of the present disclosure.

Embodiments disclosed herein may include computer program products comprising computer-executable code or computer-usable code that, when executing on one or more computing devices, performs any and/or all of the steps of the control systems described above. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the control systems described above may be embodied in any suitable transmission or propagation medium carrying computer-executable code and/or any inputs or outputs from same.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of the disclosure.

1. A system for generating hydrogen and ammonia comprising:
an electrochemical stack for generating hydrogen including:
an inlet operable to receive water from a water source; and
an anion exchange membrane, wherein the first electrochemical stack electrolyzes the water to generate hydrogen; and
a reactor for generating ammonia including:
an inlet operable to receive nitrogen and hydrogen generated in the electrochemical stack; and
an energy source activatable to reduce nitrogen to ammonia in the presence of hydrogen.

2. The system of claim 1, wherein the energy source includes a synthesis cell having a cathode, an anode, and a proton exchange membrane disposed between the cathode and the anode.

3. The system of claim 2, wherein the proton exchange membrane comprises a perfluorosulfonic acid polymer or copolymer, sulfonated poly(ether ether ketone) (sPEEK), sulfonated phenylated poly(phenylene) (sPPP), sulfonated polyether (sulfone) (SPES), sulfonated polystyrene-b-poly(ethylene-r-butylene-b-polystrene (S-SEBS), or combinations thereof.

4. The system of claim 1, wherein the electrochemical stack further includes a cathode and an anode, and the anion exchange membrane is disposed between the cathode and the anode.

5. The system of claim 1, wherein the anion exchange membrane includes imidazolium functionalized styrene polymers, polysulfone and derivatives thereof, polymers with quaternary phosphonium groups, or combinations thereof.

6. The system of claim 1, wherein the water source comprises saline water.

7. The system of claim 6, wherein the saline water comprises sodium and chloride salts.

8. The system of claim 1, wherein the electrochemical stack further includes a first outlet operable to deliver hydrogen from the electrochemical stack, and a second outlet operable to deliver a secondary gas comprising oxygen from the electrochemical stack.

9. The system of claim 1, further comprising a desalination system fluidly coupled to the electrochemical stack to provide desalinated water to the electrolchemical stack.

10. The system of claim 1, further comprising an ion exchange system fluidly coupled to the water source and to the electrochemical stack.

11. The system of claim 1, further comprising a chlor-alkali stack fluidly coupled to the water source and to the electrochemical stack.

12. The system of claim 11, wherein the chlor-alkali stack includes an anode, a cathode, and a proton exchange membrane.

13. The system of claim 1, further comprising a hydrogen storage system fluidly coupled to the electrochemical stack.

14. The system of claim 1, further comprising an electrochemical hydrogen pump fluidly coupled to an outlet of the ammonia reactor to remove unreacted hydrogen gas.

15. The system of claim 14, wherein the electrochemical hydrogen pump includes an anode, a cathode, and a proton exchange membrane.

16. The system of claim 1, further comprising a phase separator fluidly coupled to an outlet of the electrochemical stack to remove water from the generated hydrogen.

17. The system of claim 16, wherein the phase separator is fluidly coupled to the inlet of the ammonia reactor.

18. A system for generating hydrogen and ammonia, the system comprising:
a desalination system operable to remove salts from saline water, thereby generating desalinated water;
an electrochemical stack for generating hydrogen including:
an inlet operable to receive the desalinated water from the desalination module; and
an anion exchange membrane, wherein the first electrochemical stack electrolyzes the desalinated water to generate hydrogen; and
a reactor for generating ammonia including:
an inlet operable to receive nitrogen and hydrogen generated in the electrochemical stack; and
an energy source activatable to reduce nitrogen to ammonia in the presence of hydrogen.

19. A system for generating hydrogen and ammonia, the system comprising:
a chlor alkali stack operable to remove chlorine from saline water, thereby generating dechlorinated water;
an electrochemical stack for generating hydrogen including:
an inlet operable to receive the dechlorinated water from the chlor alkali stack; and
an anion exchange membrane, wherein the first electrochemical stack electrolyzes the sodium hydroxide solution to generate hydrogen; and
a reactor for generating ammonia including:
an inlet operable to receive nitrogen and hydrogen generated in the electrochemical stack; and
an energy source activatable to reduce nitrogen to ammonia in the presence of hydrogen.

20. A system for generating hydrogen comprising:
an electrochemical stack for generating hydrogen including:
an inlet operable to receive water from a water source;
an anion exchange membrane, wherein the first electrochemical stack electrolyzes the water to generate hydrogen; and
an outlet to be fluidly coupled to a reactor for generating ammonia.

21. A method for generating hydrogen and ammonia comprising:
generating hydrogen in an electrochemical stack including:
an inlet operable to receive water from a water source; and
an anion exchange membrane, wherein the first electrochemical stack electrolyzes the water to generate hydrogen; and
generating ammonia in a reactor including:
an inlet operable to receive nitrogen and hydrogen generated in the electrochemical stack; and
an energy source activatable to reduce nitrogen to ammonia in the presence of hydrogen.
